(19) United States
(12) Patent Application Publication
(10) Pub. No.: US 2009/0258247 A1
(43) Pub. Date: Oct. 15, 2009

(54) Anisotropic Soft Ceramics for Abradable Coatings in Gas Turbines

(75) Inventors: Anand A. Kulkarni, Oviedo, FL (US); David B. Allen, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/101,460

(22) Filed: Apr. 11, 2008

(51) Int. Cl. C03C 29/00

(52) U.S. Cl. 428/632

(57) ABSTRACT

A layered abradable thermal barrier coating (TBC) 20 that is stable, abradabie, and sinter resistant up to about 1400° C. A tungsten bronze structured ceramic of the form Ba₆₋₃ₓRE₈₊₂ₓTi₁₈O₅₄, where 0<x<1.5, and RE represents a rare earth lanthanide cation, is applied as a topcoat over a yttria stabilized zirconia (YSZ) undercoat (18) on a bond-coated (17) superalloy metal structure (16). The tungsten bronze structure provides abradability and thermal conductivity. The YSZ layer is a proven concept for thermal barrier coatings, and has demonstrated better adhesion than newer chemistries This combination of layers has synergy that takes advantage of both materials to provide an abradable coating with an extended lifespan on a superalloy substrate compared to prior coatings. The topcoat may be applied with fugitive inclusions that produce porosity to increase abradabilty for improved blade tip clearance control in the turbine section of gas turbines.

### FIELD OF THE INVENTION

The invention relates to abradable thermal barrier coatings (TBCs) for high temperature gas turbine components, and particularly to TBCs for shroud ring segments.

### BACKGROUND OF THE INVENTION

In order to improve efficiency of gas turbines, the gaps between the rotating turbine blades and stator parts must be minimized and controlled. Any increase in these gaps results in power loss. Gas turbine shroud rings closely surround respective turbine blade rotor discs. Shroud rings commonly have an abradable coating that allows occasional contact by the blade tips. This allows minimum clearance without damage to the blade tips. Such abradable coatings increase the surge margin, thus increasing the stability and safety of engine flow conditions. These coatings preferentially abrade when contact is made with a mating part. The abradable coatings have low structural integrity, so they are readily abraded when they are contacted by a moving surface with higher structural integrity, such as a blade tip. The coatings are designed not to damage the mating surface.

Currently, row 1 and 2 shroud ring segments of gas turbines have a porous coating of 8YSZ ceramic (8 mol % yttria-stabilized zirconia) or another ceramic designed to insulate the structural walls of the shroud ring segments. Blade tip clearance is established by the action of the blade tips machining this coating by interference during turbine operation. The coating is prepared by co-spraying a mixture of 8YSZ ceramic powder and a fugitive material to produce an abradable coating. However, resistance of 8YSZ to sintering is insufficient for gas turbine operation temperatures up to 1400° C. Such operational sintering increases the density of the coating, and thus reduces its abradability, leading to blade tip wear.

For materials background, a perovskite structure has crystal unit octahedra linked in a regular cubic array forming a high symmetry m3m prototype. A small 6-fold coordinated site in the center of each octahedron is filled by a small, highly charged (3, 4, 5 or 6 valent) cation. A larger 12-fold coordinated “interstitial” site between octahedra carries a larger mono, di, or trivalent cation.

### BRIEF DESCRIPTION OF THE DRAWINGS

The invention is explained in the following description in view of the drawings that show:

FIG. 1 illustrates a layered abradable thermal barrier coating for a superalloy substrate per aspects of the invention.

FIG. 2 is a schematic example of a tungsten bronze structured ceramic material Ba_{4.5}Gd₉Ti₁₈O₅₄

FIG. 3 illustrates a unit cell of a first layer of a Ba_{4.5}RE₉Ti₁₈O₅₄ material.

FIG. 4 illustrates a unit cell of a second layer of the Ba_{4.5}RE₉Ti₁₈O₅₄ material of FIG. 3.

FIG. 5 illustrates a unit cell of a third layer of the Ba_{4.5}RE₉Ti₁₈O₅₄ material of FIG. 3.

### DETAILED DESCRIPTION OF THE INVENTION

Sinter resistant compositions for thermal barrier coatings (TBCs) are described in this disclosure to overcome the prior problems of densification of abradable TBCs. Tungsten bronze structured ceramics have large complex unit cells with anisotropic atomic bonding and high atomic mass. These characteristics reduce thermal conductivity.

A tungsten bronze ceramic structure can be constructed from a perovskite lattice through suitable crystallographic shear. The tungsten bronze structure is basically a stack of corner-linked perovskite-like sheets separated by oxide layers, leading to a high d33 to d31 ratio (high degree of anisotropy). Like perovskites, this structure contains oxygen octahedra, but they are linked in such a way that they create 3 types of openings, two of which contain an A ion. The B ions are inside the octahedra. Also, the rotations of the octahedra evident in the a-b plane of the structure reduce the point symmetry to tetragonal (4 mmm) with layers stacked in a regular sequence along the 4-fold (c) axis. This arrangement distinguishes two inequivalent 6-fold coordinated B sites at the centers of inequivalent octahedra in perovskites from 5, 4 and 3 sided tunnels for the A site cations extending along the c axis in tungsten bronze. The open nature of the tungsten bronze structure as compared to perovskite permits a wide range of cation and anion substitutions.

A particular range of tungsten bronze structured ceramics is defined herein as Ba₆₋₃ₘRE₈₊₂ₘTi₁₈O₅₄, where 0<m<1.5 and RE represents one of the following rare earth lanthanide cations: lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu). This range of compositions exhibits excellent phase stability and improved sintering resistance up to about 1400° C. Furthermore, a layered crystal structure with weak interlayer bonding creates an intrinsic mechanical anisotropy in elastic modulus, thus providing compliance. The layers easily bend and separate, providing softness and abradability. Compared to existing ceramics for TBCs, these materials offer lower lattice thermal conductivity, improved high temperature thermo-mechanical properties and phase stability, and negligible intrinsic optical phonon-phonon coupling.

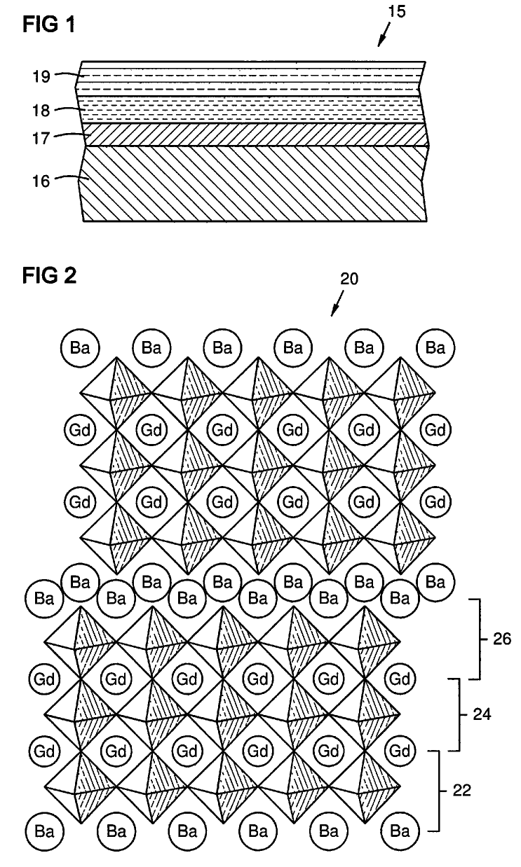

Along with improved abradability, the system needs to provide the necessary system integrity. For this purpose, the new abradable systems may be deposited in a bilayer fashion where the tungsten bronze coatings are deposited as a ceramic topcoat, and the ceramic undercoat is a standard 8YSZ chemistry that is still designed to have maximum adherence to the underlying substrate/bond coat material and also to resist failure when subjected to thermal cycling. Thus, this system is compatible with known bond coats, such as MCrAlY (M is nickel and/or cobalt), and with superalloy metal structures used in gas turbine components. FIG. 1 shows such a layered TBC system configuration 15, having a substrate 16, a bond coat 17, a YSZ underlayer 18, and a tungsten bronze structured ceramic topcoat 19.

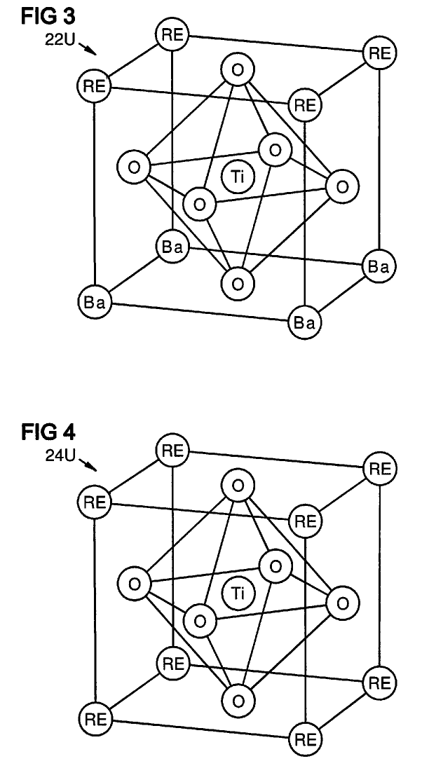

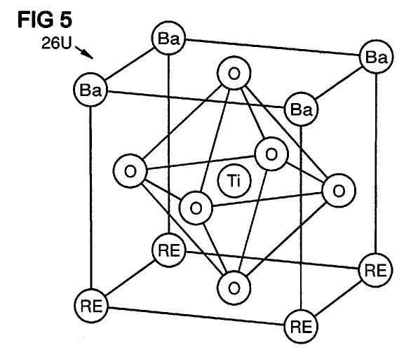

The properties of tungsten bronze structured ceramics depend on their crystal structure, stoichiometry, and phase composition. FIG. 3 illustrates a Ba_{4.5}RE₉Ti₁₈O₅₄ crystal structure such as Ba_{4.5}Gd₉Ti₁₈O₅₄ in a thermal barrier layer 20, having first second and third crystal layers 22, 24, 26 that differ from each other in composition and/or orientation. FIGS. 3, 4, and 5 further illustrate example unit cells 22U, 24U, and 26U in these respective layers 22, 24, and 26.

Typically, the crystal structure of rare earth BaO-RE₂O₃-xTiO₂ changes with varying TiO₂ content. The structure of such compounds with a lower Ti-content (x=2 and 3) exhibits aligned layers of oxygen octahedrons with intermediate barium layers as in FIGS. 3-5. Compounds with x=4 and 5 (BaRETi₄ and BaRETi₅) exhibit a structure with several tilted oxygen's octahedrons, similar to a complex perovskite structure, and vacancies partially occupied by heavy ions like barium and rare earths.

Examples of these chemistries with neodymium substitution are BaNd₂Ti₃O₁₀, BaNd₂Ti₄O₁₂ and BaNd₂Ti₅O₁₄. Similarly, chemistry compositions with Samarium substitution are BaSm₂Ti₃O₁₀, BaSm₂Ti₄O₁₂ and BaSm₂Ti₅O₁₄. However, not all compositions are crystallographically possible for other rare earth elements. For example in the case of gadolinium substitution, only BaGd₂Ti₄O₁₂ composition is stoichiometrically possible.

Overall, the particular range of such soft anisotropic tungsten bronze structured ceramics claimed herein is Ba₆₋₃ₘRE₈₊₂ₘTi₁₈O₅₄, where 0<m<1.5 and RE represents a rare earth lanthanide cation. Preferred compositions are listed below:

1. BaO-RE₂O₃-xTiO₂, where x=2-5 and RE represents a rare earth lanthanide cation.

2. BaO-RE₂O₃-xTiO₂, where x=2-5 and RE represents a rare earth lanthanide 3+ ion.

3. BaO-RE₂O₃-xTiO₂, where x=2-5 and RE represents lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu).

4. BaO-RE₂O₃-xTiO₂, where x=2-5 and RE represents praseodymium (Pr), neodymium (Nd), samarium (Sm), gadolinium (Gd), dysporium (Dy) or ytterbium (Yb)

5. BaO-RE₂O₃-xTiO₂, where x=3, and RE represents praseodymium (Pr), neodymium (Nd) or samarium (Sm).

6. BaO-RE₂O₃-xTiO₂, where x=4, and RE represents praseodymium (Pr), neodymium (Nd), samarium (Sm), gadolinium (Gd), dysporium (Dy) or ytterbium (Yb).

7. BaGd₂Ti₄O₁₀ also represented as Ba_{4.5}Gd₉Ti₁₈O₅₄

8. BaNd₂Ti₄O₁₀ also represented as Ba_{4.5}Nd₉Ti₁₈O₅₄

9. BaNd₂Ti₃O₁₀

10. BaSm₂Ti₄O₁₀ also represented as Ba_{4.5}Sm₉Ti₁₈O₅₄

11. BaSm₂Ti₃O₁₀

12. BaYb₂Ti₄O₁₀ also represented as Ba_{4.5}Yb₉Ti₁₈O₅₄

13. BaPr₂Ti₄O₁₀ also represented as Ba_{4.5}Pr₉Ti₁₈O₅₄

14. BaPr₂Ti₃O₁₀

15. BaDy₂Ti₄O₁₀ also represented as Ba_{4.5}Dy₉Ti₁₈O₅₄

In order for these compositions to serve as an abradable coating, a plasma spray deposition process may be used that allows for producing an optimum layered structure along with the needed distribution and dimensions of pores and voluminous defects, which results in low in-plane elastic modulus. This, combined with the intrinsic low in-plane modulus of the weakly bonded crystal structure provides the needed abradability of the coating.

Furthermore, porosity in the coating can be increased by introducing fugitive materials such as polyester, graphite, polymethyl methacrylate, and other materials. The fugitive material burns away upon heat treatment or during engine operation, leaving pores that decrease the coating density and increase its abradability. A majority of these compositions have been prepared and deposited using atmospheric plasma spraying. Spray parameters may be selected that provided additional desirable types and fraction of defects, again to improve abradability. Also, the coatings, due to presence of TiO2 in the structure, resulted in non-stoichiometric chemistry with an oxygen deficiency. The coating may be annealed to stabilize the crystal structure. Again, the abradable coating system herein may be deposited in a layered fashion, in which a tungsten bronze coating is deposited as a ceramic topcoat, and the ceramic undercoat is standard 8YSZ chemistry.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A layered abradable thermal barrier coating material for a gas turbine component, comprising an anisotropic tungsten bronze structured ceramic as a topcoat, and Yttria Stabilized Zirconia (YSZ) as a ceramic undercoat, deposited on a bond-coated superalloy metal structure, wherein the tungsten bronze structured ceramic has the form Ba₆₋₃ₘRE₈₊₂ₘTi₁₈O₅₄, where 0<m<1.5 and RE represents a rare earth lanthanide cation.

2. The material of claim 1 comprising an anisotropic tungsten bronze structured ceramic of the form BaO-RE₂O₃-xTiO₂, where x=2-5 and RE represents a rare earth lanthanide cation.

3. The material of claim 2, wherein RE represents a rare earth lanthanide 3+ ion.

4. The material of claim 2, wherein RE represents lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu).

5. The material of claim 4, wherein RE represents praseodymium (Pr), neodymium (Nd), samarium (Sm), gadolinium (Gd), dysporium (Dy) or ytterbium (Yb)

6. The material of claim 2, wherein x=3, and RE represents praseodymium (Pr), neodymium (Nd) or samarium (Sm) in a tungsten bronze structured ceramic of the form BaRE₂Ti₃O₁₀.

7. The material of claim 2, wherein x=4, and RE represents praseodymium (Pr), neodymium (Nd), samarium (Sm), gadolinium (Gd), dysporium (Dy) or ytterbium (Yb) in a tungsten bronze structured ceramic of the form BaRE₂Ti₄O₁₀.

8. An abradable thermal barrier coating material for a gas turbine component, the coating material comprising a stack of crystal layer groups, each layer group comprising tetragonal unit cell layers of a first, a second, and a third type, each layer type of a given layer group differing from the other two layer types in the given layer group in composition and/or orientation.

9. The abradable thermal barrier coating material of claim 8, comprising BaO-RE₂O₃-xTiO₂, where x=2-5 and RE represents a rare earth lanthanide cation.

10. The abradable thermal barrier coating material of claim 9, wherein RE represents a rare earth lanthanide 3+ ion.

11. The abradable thermal barrier coating material of claim 9, wherein RE represents lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu).

12. The abradable thermal barrier coating material of claim 11 wherein RE represents praseodymium (Pr), neodymium (Nd), samarium (Sm), gadolinium (Gd), dysporium (Dy) or ytterbium (Yb)

13. The abradable thermal barrier coating material of claim 9, wherein x=3, and RE represents praseodymium (Pr), neodymium (Nd) or samarium (Sm) in a tungsten bronze structured ceramic of the form BaRE₂Ti₃O₁₀.

14. The abradable thermal barrier coating material of claim 9, wherein x=4, and RE represents praseodymium (Pr), neodymium (Nd), samarium (Sm), gadolinium (Gd), dysporium (Dy) or ytterbium (Yb) in a tungsten bronze structured ceramic of the form BaRE₂Ti₄O₁₀.

15. The abradable thermal barrier coating material of claim 8, further comprising inclusions of a fugitive material sufficient to create porosity in the coating material.
